(19) United States
(12) Patent Application Publication
(10) Pub. No.: US 2014/0120221 A1
(43) Pub. Date: May 1, 2014

(54) METHOD OF PRODUCING A DECORATIVE BAKED GOOD AND DECORATIVE BAKED GOOD PRODUCED USING SAME

(71) Applicant: Brie Darling, Valley Glen, CA (US)

(72) Inventor: Brie Darling, Valley Glen, CA (US)

(21) Appl. No.: 13/662,747

(22) Filed: Oct. 29, 2012

(51) Int. Cl. A21D 13/08; A23P 1/10; A21D 10/04

(52) U.S. Cl. 426/249; 426/549; 249/117

(57) ABSTRACT

A method for providing a decorative baked good and a product made by the method is presented. The method includes mixing a plurality of different color batters to a desired enhanced batter thickness, distributing the plurality of different color batters in multiple layers of different color multiple adjacent color segments to form a decorative batter arrangement in accordance with a pattern, and baking the decorative batter arrangement. The decorative baked good includes a plurality of layers of different color multiple adjacent color segments formed from a plurality of different color batters of a desired enhanced batter thickness in accordance with a pattern.

### BACKGROUND OF THE INVENTION

1. Field of the Invention

The present invention relates generally to food production, and more specifically to the preparation of cakes and other baked goods.

2. Description of the Related Art

Preparation techniques for cakes and other baked goods have been known for centuries. Typical baked good preparation in the case of a cake requires mixing a batter, placing the batter in a pan, placing the pan in an oven, removing the cake, applying frosting and possibly other decorations, and serving the finished cake. Multiple cake layers can be combined, such as one layer positioned atop another layer, with frosting provided between layers. Exterior decoration of such cakes can become quite elaborate, such as in the case of wedding cakes, and unusual or novel cakes and baked goods are in great demand.

However, the basic construct of the cake, and the inner portion thereof, has remained virtually unchanged for centuries. Certain cake designs have included elements mixed in with the batter, such as chocolate chips, coconut, and so forth. However, these products are randomly distributed throughout the batter, and while they add flavor and can add some level of novelty, they are fairly limited in what can be accomplished.

Some advances have been made in cake and baked good interior aesthetics. “Marble” cakes are created by randomly stirring one color batter into another before baking, with simply pouring the batters into a cake pan, stirring, and baking. Another cake design is the “checkerboard” design, which requires either special pans or baking layers of cakes and using cutting tools to cut segments out of baked cake layers to create a “checkerboard” effect. An additional cake type is a “Zebra” stripe cake, constructed by pouring alternating colors atop one another in the pan, beginning with a small volume of batter and slowly increasing the volume by pouring successive batter quantities atop the previous quantity. For example, one would pour a small amount of vanilla into the cake pan, then a small amount of chocolate on top of the vanilla, and then a further small amount of vanilla onto the previous chocolate, until the pan is filled. The effect is random striping resembling zebra striping.

Other types of baked goods are also available that employ these techniques, such as cupcakes and muffins. These items have been similarly prepared, with occasional added ingredients mixed in the batter.

There is a great interest in cake production and unique and unusual features in all types of food, including baked goods such as cakes. Any novel or unusual feature in a baked good can be highly sought after, and new creations in food production can be highly valuable.

It would therefore be advantageous to provide a novel and unique method for making decorative cakes that improves on previous cake and baked goods designs.

### SUMMARY OF THE INVENTION

According to one aspect of the present design, there is provided a method for providing a decorative baked good. The method includes mixing a plurality of different color batters to a desired enhanced batter thickness, distributing the plurality of different color batters in multiple layers of different color multiple adjacent color segments, such as concentric circular lines or relatively straight lines, to form a decorative batter arrangement in accordance with a pattern, and baking the decorative batter arrangement. In certain instances, the segments in adjacent layers can be offset, and the pattern may be irregular.

According to another aspect of the present design, there is provided a product made by the method. The product is a decorative baked good that includes a plurality of layers of different color multiple adjacent color segments formed from a plurality of different color batters of a desired enhanced batter thickness in accordance with a pattern.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 shows a blank matrix and a pattern for a circular “leopard skin” cake;

FIG. 2 illustrates the multiple layers in a circular cake distributed according to the pattern;

FIG. 3 is a representation of the circular cake including all layers, with a section removed to show the inside arrangement conforming to the pattern of FIG. 1;

FIG. 4 illustrates a cake made by the process and the associated pattern used to make the “leopard skin” embodiment of the cake;

FIG. 5 shows a blank matrix and a pattern for a rectangular “leopard skin” cake;

FIG. 6 is a view of the various layers provided for the rectangular cake;

FIG. 7 shows a representation of a rectangular cake including all layers showing formation according to the pattern of FIG. 5;

FIG. 8 illustrates an embodiment of a batter cartridge that may be used in the method disclosed herein and used to prepare the baked good provided herein;

FIG. 9 illustrates a pattern that may be employed with an arrangement of multiple batter cartridges similar to the batter cartridge shown in FIG. 8; and

FIG. 10 is an arrangement of batter cartridges joined together and including different color batters; and

FIG. 11 is a flowchart of one embodiment of the present design.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design is directed to a method for preparing a decorative cake and a decorative cake produced by the method. In general, the present design requires creation of a desired cake pattern, preparation of a cake batter having a greater level of thickness than a typical cake, but not excessively thick, in varying colors in accordance with the desired cake pattern, and distributing each of the individually colored batters in accordance with the pattern using a cake batter distributing device. Distribution of the individually colored batters can occur in different ways for different types of cakes, but in one instance, a circular cake can be made using a series of concentric circular lines made according to the pattern. In a square cake, the individually colored batters can be distributed in a series of straight lines according to the pattern. The pattern typically consists of multiple layers, and in one embodiment each layer is prepared and successive layers are provided on top of the initial layer. Once the batter has been distributed according to the pattern, the cake is prepared for baking and is baked.

A user or server cutting into the cake will reveal, and each slice of cake will have, a decorative appearance in accordance with the pattern.

The pattern is a series of shapes, such as squares, that form a decorative design. While the pattern may include regular shapes, because of the nature of cake batter, the actual shapes distributed in the cake may vary. As used herein, the term “segments” are intended to broadly represent any distribution of batter in any form, regular or irregular. Patterns may be created in any format, simply depending on the number of layers, the thickness of batter to be distributed, and the desires of the creator. The present design will be described in accordance with a unique “leopard skin” pattern, but it is to be understood that the patterns are not so limited, and numerous designs can be created using the teachings disclosed herein, such as regular and irregular designs, offset designs, and so forth.

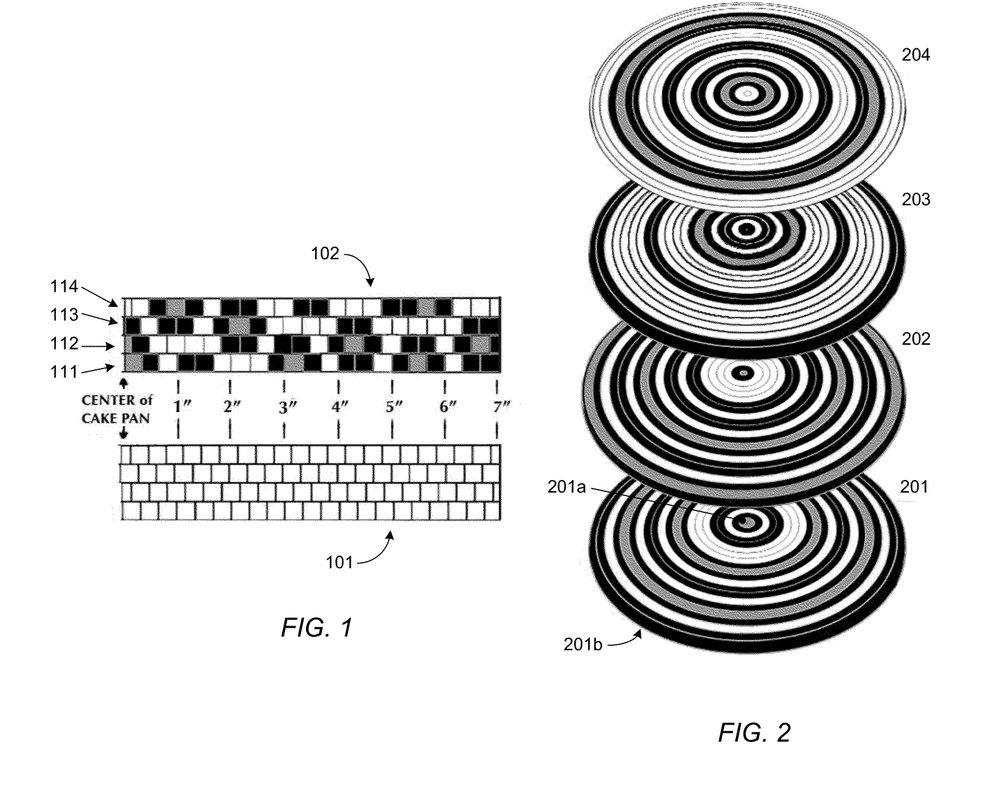

FIG. 1 illustrates a blank matrix 101, including a series of staggered squares, where pattern 101 includes four levels or layers. Designed matrix 102 reflects the “leopard skin” pattern, with dark squares representing a darker chocolate cake batter required, the lighter grey squares representing a lighter chocolate cake batter, and the white squares representing a white cake batter. As may be appreciated, any color of cake batter that can be made can be used, and larger or smaller constituent components may be used, or in other words, smaller or larger regions can form the pattern. It should be further noted that in general the squares in one row are offset from the squares in the row above and the row below. This is not mandatory, and any arrangement of constituent parts can be employed, such as square pattern regions stacked on each other, rectangles, etc. but in general, a number of rows is beneficial.

FIG. 1 includes various markings between blank matrix 101 and pattern 102, representing the size of the cake being made. For example, if the radius of the cake is 3.5 inches, a total of 7.0 inches in diameter, would result in using approximately half the pattern 102, while a 14 inch cake pan would accommodate the entire pattern as shown. The pattern shown in FIG. 1 has four rows, numbered 111 to 114, lowest to highest.

Once the pattern 102 has been created, the user can prepare the requisite batters. In the “leopard skin” design of FIG. 1, three batters are created, a dark chocolate, a light chocolate, and a white cake batter. In the present design, a standard cake batter tends to be too viscous for the intended use. Thus a thicker batter is employed, but not so thick as to be unacceptable in terms of ability for the cake to cook and/or have an unacceptable taste. Standard cake batters tend to be generally the same, with certain minor differences, and a variety of ready-made cake batters are available. In general, the amount of liquid components is decreased or the amount of solid components is increased to achieve the requisite thickness. In other words, the batter has an enhanced or increased ratio of thickening components or ingredients to liquid components, where thickening components may include, but are not limited to, solids such as powders, as well as components such as butter, shortening, congealed vegetable oil, gelatin, and so forth.

Commercially available boxed cake mixes may be employed, typically by enhancing, adjusting and/or replacing some or all of the ingredients called for in the directions provided on the box. Certain substitutions of ingredients may also be made. As an example, butter may be used rather than oil, and/or less water may be added to a commercial cake mix than is called for in the directions. Alternately, certain preparation techniques to achieve the enhanced thickness may be employed, such as combining or whisking eggs and separately creaming butter before adding these ingredients to a commercially available mix, which can keep the batter from becoming excessively dense.

Cake batter is generally made with flour, baking powder, sugar, milk or buttermilk, shortening, eggs, and sometimes ingredients such as salt, vanilla extract, and butter. In general, acknowledging that different chefs work in different ways, the main/most voluminous ingredients tend to be flour, sugar, milk, eggs, and shortening, in ratios such as 2 cups of sugar, 1 cup of butter, 3 eggs, 3 cups flour, and 1 cup buttermilk Tablespoons or teaspoons of other common ingredients are typically employed. In certain instances, two types of batter can be combined together, such as one using cocoa powder and one not using cocoa powder to achieve a desired color, i.e. a light brown color, while attaining the requisite thickness. Again, variations of this batter composition may be constructed in accordance with the teachings provided herein.

The present design alters the batter recipe to be thicker, typically by adding more flour, adding a not insignificant amount of a thickening component or thickening ingredient, for example as cocoa powder, and adding less sugar depending on taste. This results in an increase in the amount of thickening components in the range of 10 to 25 percent, but these values are approximate. Alternately, rather than using cocoa powder, more flour may be employed, in addition to combinations including more eggs and/or egg whites and/or butter or other thickening components. Ingredients can be mixed at different times to increase or decrease thickness, and techniques such as heating or cooling may be employed. Other solid or thickening ingredients may be added while the liquid or semi-liquid ingredients stay at the same level or are decreased. But again, the goal is to make a cake batter that is thicker than normal, able to be provided alone in a cake pan and hold shape without running, but not a batter that is overly thick. One skilled in the baking arts would be able to produce such a batter with minimal effort and minor experimentation.

Once the batter has been prepared, the batter is distributed in lines in a rectangular cake and in concentric circles or concentric circular lines in a round cake, according to the pattern in both cases. Different layers are distributed on top of lower layers. FIG. 2 shows a four layer round cake in accordance with pattern 102. Bottom layer 201 is established first, from the inside concentric circle 201a (narrowest concentric circle, left side of pattern 102) out to the outside concentric circle 201b (largest concentric circle, in FIG. 2 the right side of pattern 102. Once this layer has been produced, typically in a cake pan, the second layer 202 is produced, followed by third layer 203 and fourth layer 204. As may be appreciated, the concentric circular lines in each layer 201-204 correspond directly to pattern 102, with layer 201 corresponding to row 111 in the pattern 102, layer 202 corresponding to row 112, and so forth.

Distributing batter may be done by a machine or by hand. If done by hand, a piping bag with an appropriate end should be employed. In one configuration, the cake batter may achieve a consistency sufficient to roll the batter into a “rope” or “bullet” like configuration, and the “rope” or “bullet” may be distributed via a piping bag. In general, the batter should have a consistency such that it does not run out of a standard piping bag. The piping bag may have any appropriate nozzle shape, including but not limited to round, square, and rectangular of different dimensions based on the desired pattern.

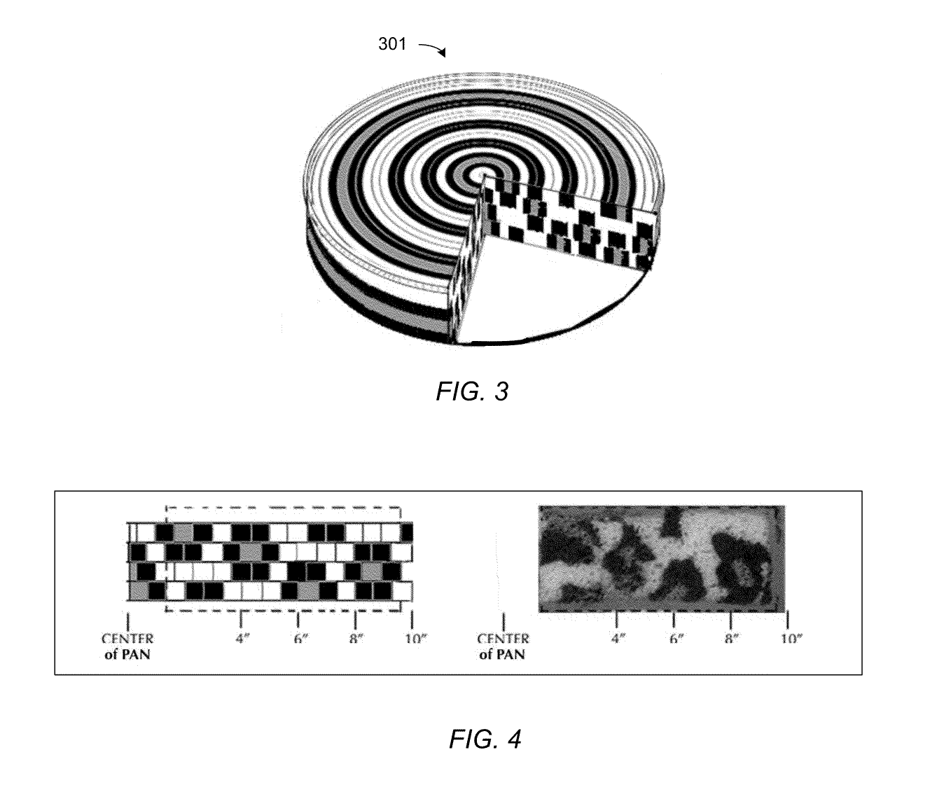

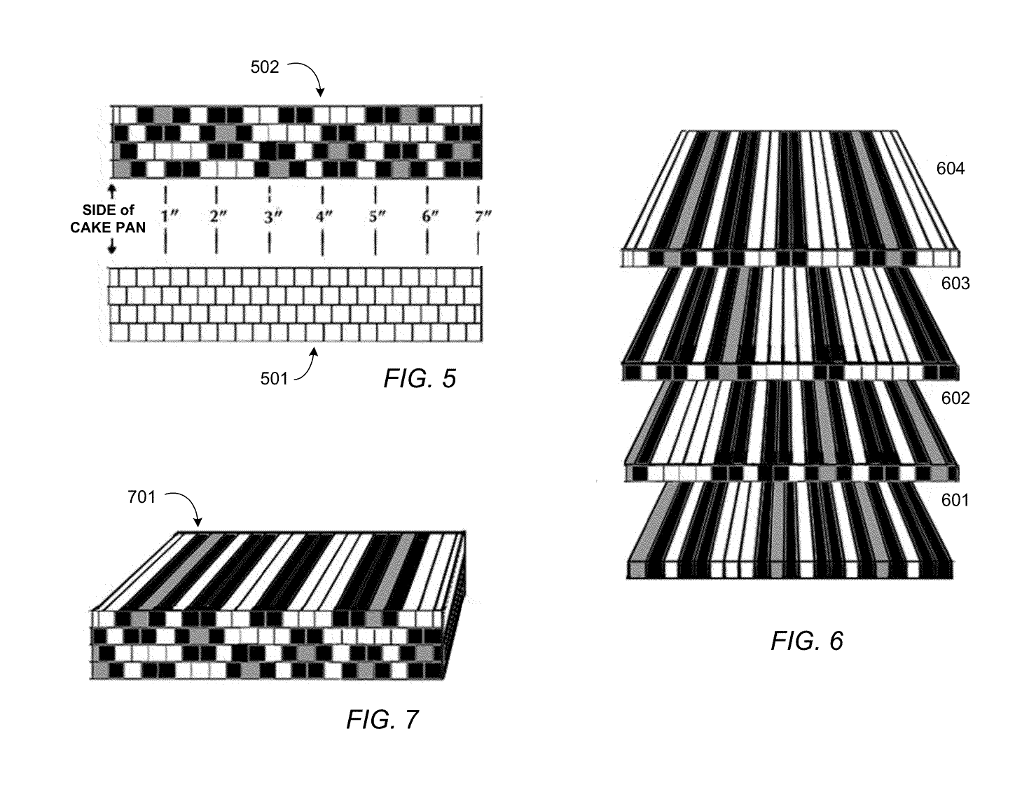

FIG. 3 illustrates the fully provided cake batter arrangement 301, with all four layers. The cake batter arrangement is ready for baking at this stage, and for purposes of illustration, a section is cut out and the cross section shows the layers corresponding to pattern 102. FIG. 4 illustrates one representation of a finished round cake in accordance with the present design as cake section 401, which corresponds to the dotted line around pattern 402.

Even when care is taken in establishing the concentric circular lines, it is understood that either when the batter is provided in concentric circular lines and layers or during baking, a perfect shape may not be maintained as batter may run together. Thus patterns and designs that have some level of abstraction or non-perfect qualities can produce the best results.

The pan may be prepared in a typical manner consistent with baking a cake, with a desire to maintain the overall shape of the cake with little rising variation, such as the center rising more than the edges. Butter, shortening, or known commercially available products may be applied to the inside of the pan (not shown). A silicone pad may be employed, typically without any grease, butter, shortening, etc. A specially created heat resistant pad, such as a silicone pad, may be employed (not shown). Such a specially made silicone pad may include small ridges formed therein in dimensions similar to the desired blank matrix. The ridges so formed may be linear, circular, or another appropriate shape and represent guides for piping the first layer of batter lines in accordance with the teachings herein. Parchment paper, with or without the concentric circle markings, may be employed at the base of the pan as a guide for distributing batter. Certain absorbent products, such as terry cloth towel strips, or commercially available baking strips, may be moistened and/or provided around the exterior side of the pan to keep the outer edge of the cake from rising slower than the center. Such moistened strips or items may be affixed to the inner edge of the pan using a holding device, such as a clip or clips, for example metal clips.

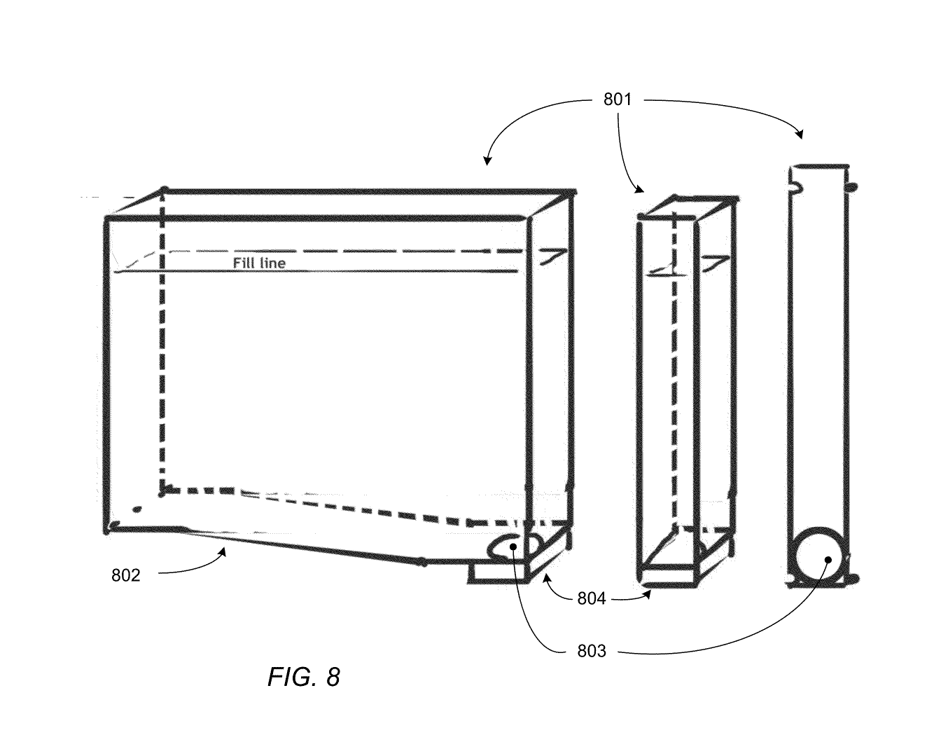

FIG. 5 illustrates a pattern that may be used to create a “leopard skin” rectangular cake design. Blank matrix 501 may be used to create pattern 502, with markings shown for different dimension cakes in this embodiment. Other dimensions may be employed. FIG. 6 illustrates the four layers to be provided in accordance with the present design, typically in a rectangular pan (not shown), including layers 601-604. FIG. 7 illustrates the completed cake layers 701 as they would be provided in a rectangular pan, again corresponding to pattern 502.

As noted, the various layers of batter may be provided by hand. Alternately, a machine may be employed that distributes batter made in accordance with the teachings herein. Three views of one example of such a device are shown in FIG. 8, with batter cartridge 801 configured to distribute batter. Batter cartridge 801 includes a sloping base 802, a distribution opening 803, and may include an edge such as edge 804. In operation, the opening through distribution opening 803 may be mechanically and/or electrically controlled, such as by a movable flap or door. Such an arrangement may be combined with other similar batter cartridges, such as in a line, side by side, with the various batter cartridges containing different batters in accordance with the pattern provided. In this case, a batter cartridge to distribute the smallest, central concentric circle may have its opening/distribution hole opened and closed rapidly, while outer rings/outer batter cartridges may be opened and held open for a relatively long time to provide the proper amount of batter in a larger diameter circle. In the case of a rectangular cake, openings in each batter cartridge would be opened and closed at the same time.

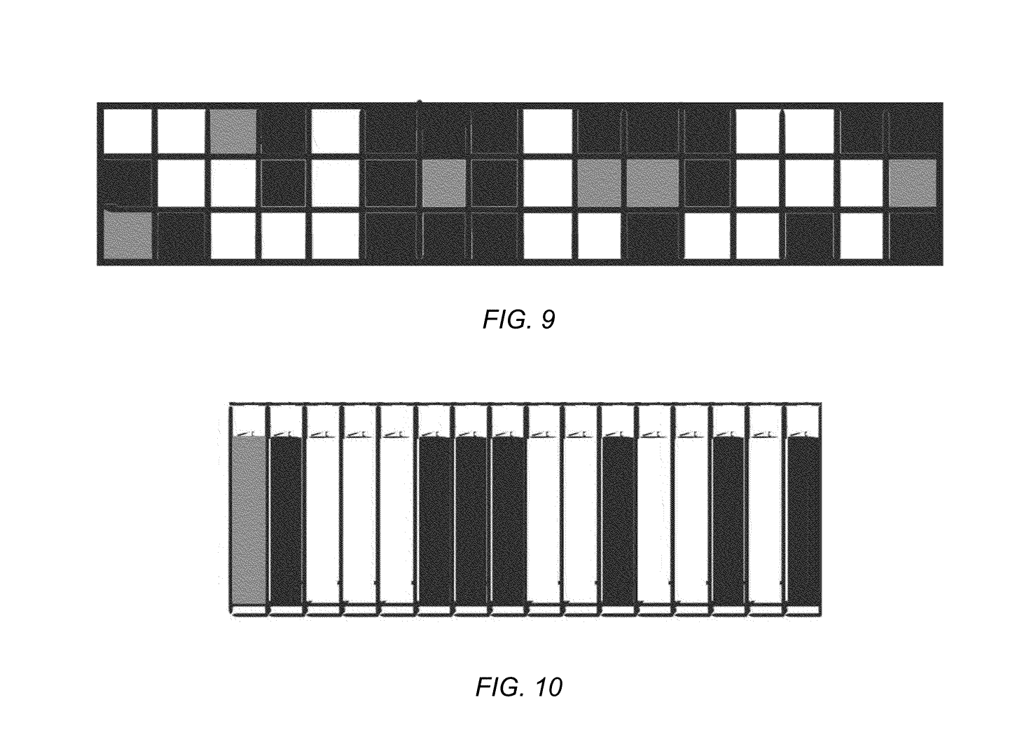

One example of a pattern using this embodiment is illustrated in FIG. 9. As shown, each layer is atop another layer rather than offset, due to the cartridges being of fixed sizes. As noted, when distributing the various layers, the cartridges may be reordered or rearranged, and in one embodiment the cartridges may have a snap attachment or connecting capability with adjacent batter cartridges such that they can be rearranged to provide batter according to the pattern. Multiple batter cartridges arranged side by side are shown in FIG. 10. In such an arrangement, layers are typically going to be uniform, similar to the pattern 901 in FIG. 9. Alternately, a number of special batter cartridges may be employed, such as a batter cartridge only half or one quarter as large as all other cartridges provided. These smaller cartridges could be selectively provided at either end of a multiple batter cartridge arrangement and could achieve a desired pattern with an offset layer arrangement similar to the preceding embodiments.

It should be noted that while described herein with respect to cakes, many types of baked products may be produced using the teachings provided herein, including but not limited to cupcakes, muffins, and other baked goods, typically of circular or rectangular shape.

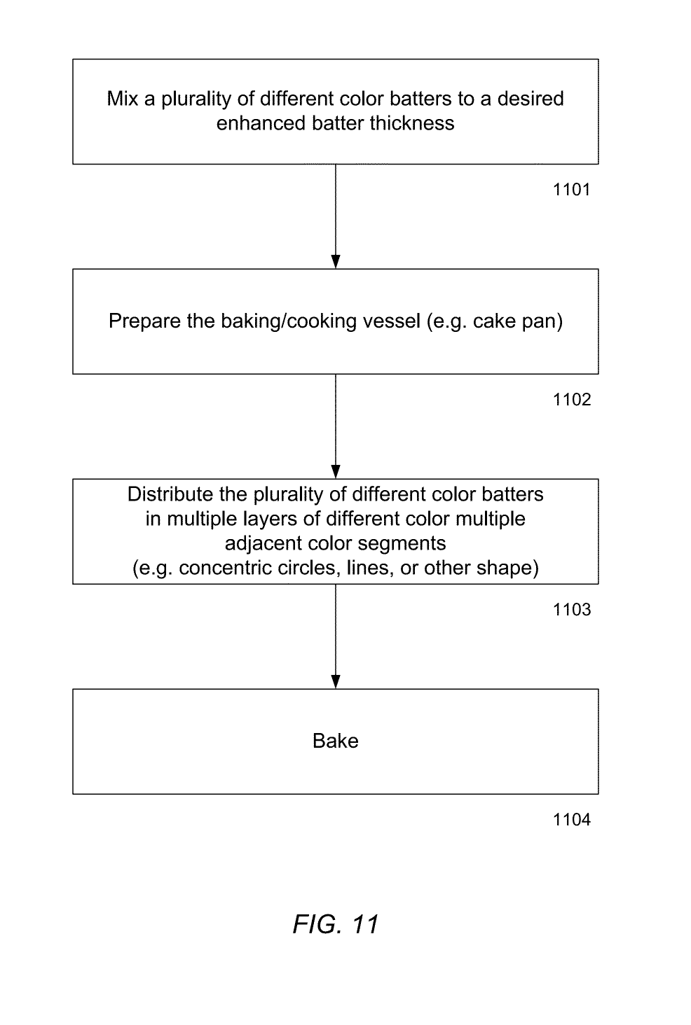

One embodiment of the present process is shown in FIG. 11. From FIG. 11, point 1101 calls for mixing a plurality of different color batters to a desired enhanced batter thickness. Point 1102 calls for preparing the baking or cooking vessel, such as a cake pan, in, for example, a manner as described herein. Point 1103 calls for distributing the plurality of different color batters in multiple layers of different color multiple adjacent color segments, where the segments may be concentric circular lines or lines or other appropriate shape. Point 1004 is the baking of the food product.

Thus the present design includes a method for providing a decorative baked good. The method may include mixing a plurality of different color batters to a desired enhanced batter thickness, distributing the plurality of different color batters in multiple layers of different color multiple adjacent color segments to form a decorative batter arrangement in accordance with a pattern, and baking the decorative batter arrangement. The pattern may be regular or irregular. The method may also include preparing a vessel prior to distributing the plurality of different color batters, wherein the plurality of different color batters is distributed in the vessel. The different color multiple adjacent color segments may include a plurality of concentric circular lines of batters of varying colors forming each layer when the vessel is a circular pan, and a plurality of relatively straight batter lines of varying colors forming each layer when the vessel is a rectangular pan. Each layer may be offset from each adjacent layer. Distributing batter may be accomplished using a piping bag or a device configured to distribute the batters. Each batter may be prepared using a greater thickening component to liquid ratio than a generic batter.

According to an alternate embodiment, there is provided a decorative baked good, including a plurality of layers of different color multiple adjacent color segments formed from a plurality of different color batters of a desired enhanced batter thickness in accordance with a pattern. Again, the pattern may be regular or irregular. The baked good may be formed in a circular shape and the different color multiple adjacent color segments formed as concentric circular lines, or the baked good formed in a noncircular shape and the different color multiple adjacent color segments formed as relatively straight lines.

While primarily described herein with respect to an exemplary decorate cake process and method for making same, the invention and disclosure herein are not intended to be so limited. Note that while certain examples are provided herein, these examples are meant to be illustrative and not limiting as to the functionality of the present system and method. Other examples and implementations are possible and this document should not be limited by the examples presented. Other examples of decorative baked goods may be realized using the current design.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for providing a decorative baked good, comprising:
mixing a plurality of different color batters to a desired enhanced batter thickness;
distributing the plurality of different color batters in multiple layers of different color multiple adjacent color segments to form a decorative batter arrangement in accordance with a pattern; and
baking the decorative batter arrangement.

2. The method of claim 1, further comprising preparing a vessel prior to distributing the plurality of different color batters, wherein the plurality of different color batters is distributed in the vessel.

3. The method of claim 1, wherein the plurality of different color batters is distributed in a vessel, and wherein the different color multiple adjacent color segments comprise a plurality of concentric circular lines of batters of varying colors forming each layer, and wherein the vessel comprises a circular pan.

4. The method of claim 1, wherein the plurality of different color batters is distributed in a vessel, and wherein the different color multiple adjacent color segments comprise a plurality of relatively straight batter lines of varying colors forming each layer, and wherein the vessel comprises a rectangular pan.

5. The method of claim 3, wherein each layer of concentric circular lines of batters is offset from each adjacent layer.

6. The method of claim 4, wherein each layer of relatively straight batter lines is offset from each adjacent layer.

7. The method of claim 1, wherein the distributing comprises providing the different color batters using a piping bag.

8. The method of claim 1, wherein the plurality of different color batters each comprise a batter prepared using a greater thickening component to liquid ratio than a generic batter.

9. The method of claim 1, wherein the pattern is irregular.

10. A decorative baked good, comprising:
a plurality of layers of different color multiple adjacent color segments formed from a plurality of different color batters of a desired enhanced batter thickness in accordance with a pattern.

11. The decorative baked good of claim 10, wherein the pattern is irregular.

12. The decorative baked good of claim 10, wherein the baked good is formed in a circular shape and the different color multiple adjacent color segments are formed as concentric circular lines.

13. The decorative baked good of claim 10, wherein the baked good is formed in a noncircular shape and the different color multiple adjacent color segments are formed as relatively straight lines.

14. A method for providing a decorative baked good, comprising:
distributing a plurality of different color batters having a desired enhanced batter thickness in multiple layers of different color multiple adjacent color segments to form a decorative batter arrangement in accordance with a pattern; and
baking the decorative batter arrangement.

15. The method of claim 14, further comprising preparing a vessel prior to distributing the plurality of different color batters, wherein the plurality of different color batters are distributed in the vessel.

16. The method of claim 14, wherein the plurality of different color batters are distributed in a vessel, and wherein the different color multiple adjacent color segments comprise a plurality of concentric circular lines of batters of varying colors forming each layer, and wherein the vessel comprises a circular pan.

17. The method of claim 14, wherein the plurality of different color batters are distributed in a vessel, and wherein the different color multiple adjacent color segments comprise a plurality of relatively straight batter lines of varying colors forming each layer, and wherein the vessel comprises a rectangular pan.

18. The method of claim 16, wherein each layer of concentric circular lines of batters is offset from each adjacent layer.

19. The method of claim 17, wherein each layer of relatively straight batter lines is offset from each adjacent layer.

20. The method of claim 14, wherein the plurality of different color batters each comprise a batter prepared using a greater thickening component to liquid ratio than a generic batter.

21. The method of claim 14, wherein the pattern is irregular.

22. An apparatus, comprising:
a relatively flat surface having a plurality of ridges formed therein, the plurality of ridges separated on the relatively flat surface by a distance conducive to receiving multiple adjacent segments of batter.

23. The apparatus of claim 22, further comprising at least one side, where the apparatus is a cake pan.

24. The apparatus of claim 22, wherein the relatively flat surface comprises a heat resistant relatively flat surface sized to fit within a standard cake pan.
